(19) United States
(12) Patent Application Publication
(10) Pub. No.: US 2006/0067739 A1
(43) Pub. Date: Mar. 30, 2006

(54) Apparatus for uniformly supplying developer and image forming apparatus having the same

(75) Inventors: Dong-ju Kang, Anyang-si (KR); Yong-su Kim, Yongin-si (KR); Jean-man Sur, Suwon-si (KR); Sang-don Lee, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/224,032

(22) Filed: Sep. 13, 2005

(30) Foreign Application Priority Data
Sep. 24, 2004 (KR) 2004-76892

(51) Int. Cl. G03G 15/10

(52) U.S. Cl. 399/237; 399/238

(57) ABSTRACT

An apparatus for uniformly supplying the liquid developer and an image forming apparatus having the same are provided. The developer supplying apparatus includes a manifold connected to a connection tube for supplying a liquid developer from an outside and having a developer inlet through which the liquid developer flows into a developing chamber, and a developer dispersion unit, disposed in the developing chamber and located adjacent to an upper part of the developer inlet, for guiding the liquid developer flowing into the developing chamber through the developer inlet so that the liquid developer is dispersed in a horizontal direction. The liquid developer flowing into the lower part of the developing chamber does not directly move toward the upper part of the developing chamber, but is dispersed in a horizontal direction, so that the liquid developer is uniformly dispersed into the whole part of the developing chamber.

### CROSS-REFERENCE TO RELATED APPLICATIONS

This application claims the benefit under 35 U.S.C. § 119(a) of Korean Patent Application No. 2004-76892, filed on Sep. 24, 2004, the entire disclosure of which is hereby incorporated by reference.

### BACKGROUND OF THE INVENTION

1. Field of the Invention

The present invention relates to an image forming apparatus such as a wet electrophotographic printer which uses a liquid developer. More particularly, the present invention relates to an image forming apparatus which is capable of uniformly supplying the liquid developer into a developing chamber of a developing unit.

2. Description of the Related Art

In general, an image forming apparatus such as a wet electrophotographic printer is provided with a developer supplying system. The developer supplying system supplies a liquid developer to a developing unit to form an image. The developer supplying system is classified into an integral type developer supplying system or a detachable type developer supplying system. In an integral type developer supplying system, the developer cartridge and a developing unit are integrally formed. Alternatively, in a detachable type developer supplying system, the developer cartridge is connected to a developing unit by a connection tube.

Typically, the detachable type developer supplying system supplies the developer from the developer cartridge to the developing unit through the connection tube by use of a developer supplying pump. Then, the developer is collected from the developing unit and transferred to the developer cartridge by use of a developer recovery pump.

FIG. 1 is a schematic view of a conventional wet electrophotographic printer 10 which employs a detachable type developer supplying system.

The wet electrophotographic printer 10 includes an image forming unit 11 and a developer supplying unit 21.

The image forming unit 11 includes a photoconductor 1 such as an organic photoconductive drum (OPC drum), a laser scanning unit 4, a charging unit 6, a discharging unit 7, a developing unit 26, and a cleaning blade 8. These components operate in cooperation with one another to sequentially perform an image forming process such as charging, discharging, exposing, and developing. Thus, a desired image is formed on the photo conductor 1.

The developing unit 26 is provided with a developing chamber 27 for retaining a liquid developer 48 therein. At a lower side of the developing chamber 27, a first developer inlet 13 for receiving an inflow of the liquid developer 48 is formed. The first developer inlet 13 receives the inflow of liquid developer 48 from the developer cartridge 15 through first and second connection tubes 22 and 23.

As illustrated in FIGS. 1 and 2, the first developer inlet 13 has a manifold 32 to serve as an apparatus for uniformly supplying the liquid developer 48 into the developing chamber 27. The manifold 32 is connected to the second connection tube 23. The manifold also includes a flange 39 and a cover 38. The flange 39 is formed at a lower part of a first side wall 28 of the developing chamber 27. The flange 39 is provided with a developer inlet 43 for receiving an inflow of the liquid developer 48 to the lower part of the developing chamber 27. The developer inlet 43 is formed with first and second elongated openings 34 and 35 which are spaced apart from one another. The cover 38 is inserted into and fixed to the flange 39 by means of fixing means such as a screw.

The developing unit 26 is provided on an upper part thereof with a developer supplying unit 21. The developer supplying unit supplies liquid developer 48 into the developing chamber 27. The developer supplying unit 21 includes a developer cartridge 15, a developer supplying pump 18, a developer recovery pump 19, and a controller 29.

In the conventional wet electrophotographic printer 10 described above, the flange 39 of the manifold 32 for supplying the liquid developer 48 into the developing chamber 27 has the developer inlet 43 composed of the first and second openings 34 and 35. Therefore, the liquid developer 48 that flows into the developing chamber 27 through the first and second openings 34 and 35 cannot be uniformly dispersed over the entire developing chamber 27. The liquid developer 48 mostly moves only upward from the first and second openings 34 and 35 in a direction indicated by an arrow A in FIG. 2. Consequently, the liquid developer 48 is concentrated in the center part of the developing chamber 27.

If the supply amount of the liquid developer 48 flowing into the developing chamber 27 is not uniform or the flow rate of the liquid developer being supplied is changed, then the amount of liquid developer 48 used to form a toner image on the photoconductor 1 is directly affected. As a result, an insufficient supply or an excessive supply of the liquid developer 48 may occur. Consequently, image defects such as snow flakes may be present in the final image formed due to the insufficient supply of liquid developer 48 onto the photoconductor 48.

FIG. 3 is a graph which illustrates the results of measuring speed distribution of the liquid developer 48 at an outlet of the developing chamber 27 having the developer inlet 13 illustrated in FIGS. 1-2. According to this measurement, the liquid developer 48 was supplied at a speed of about 50% (that is, 450 ml/min) of the standard (900 ml/min). As apparent from the graph in FIG. 3, the liquid developer 48 is concentrically supplied to the center part between the first and second openings 34 and 35, but is not evenly supplied to the longitudinal edges of the developing chamber 27. As stated above, if the liquid developer is insufficiently supplied to the longitudinal edges of the developing chamber 27, an image defect such as a snow flake may be formed in the longitudinal edges of the final image formed.

Accordingly, there is a need for an improved apparatus for uniformly supplying a developer of an image forming apparatus.

### SUMMARY OF THE INVENTION

An aspect of the present invention is to solve at least the above problems and/or disadvantages and to provide at least the advantages described below. Accordingly, an aspect of the present invention is to provide an apparatus for uniformly supplying a developer and an image forming apparatus having the same that can uniformly keep the flow dispersion of a developer supplied into a developing chamber of a developing unit.

The foregoing and other objects and advantages are substantially realized by providing an apparatus for uniformly supplying a developer of an image forming apparatus which comprises a manifold connected to a connection tube for supplying a liquid developer from an outside. The manifold also includes a developer inlet through which the liquid developer flows into a developing chamber, and a developer dispersion unit, disposed in the developing chamber and located adjacent to an upper part of the developer inlet, for guiding the liquid developer flowing into the developing chamber through the developer inlet. Thus, the liquid developer is dispersed in a horizontal direction.

It is also preferable that the developer inlet have at least two openings formed on a lower part of the developing chamber in a spaced-apart relation from one another. The developer dispersion unit has at least two partitions disposed between a first side wall and an opposed second side wall of the developing chamber adjacent to upper parts of the two openings. The at least two partitions of the developer dispersion unit preferably extend horizontally as long as the width of the corresponding opening, respectively.

Alternatively, the developer inlet may have one opening formed in a horizontal direction on the upper part of the developing chamber, and the developer dispersion unit may have at least two partitions disposed between a first side wall and an opposed second side wall of the developing chamber adjacent to an upper part of the opening. In this arrangement, the at least two partitions extend horizontally in a spaced-apart relation from one another.

According to another aspect of the present invention, there is provided an image forming apparatus comprising an image forming unit having a developing unit provided with a developing chamber for retaining a liquid developer therein. The image forming apparatus is also capable of forming an image by developing an electrostatic latent image using the liquid developer, a developer supplying unit having a developer cartridge for storing the liquid developer therein, a connection tube for connecting the developing unit with the developer cartridge, and at least one developer pump for supplying the liquid developer from the developer cartridge to the developing unit through the connection tube. The image forming apparatus can recover the liquid developer from the developing unit to the developer cartridge through the connection tube, and has a uniform developer supplying apparatus to maintain uniform flow dispersion of the liquid developer supplied into the developing chamber of the developing unit. The developer supplying apparatus comprises a manifold connected to the connection tube and has a developer inlet through which the liquid developer flows into the developing chamber. Additionally, the developer supplying apparatus has a developer dispersion unit which is disposed in the developing chamber and located adjacent to an upper part of the developer inlet to guide the liquid developer flowing into the developing chamber through the developer inlet so that the liquid developer is dispersed in a horizontal direction.

It is preferable that the developer inlet may have at least two openings formed on a lower part of the developing chamber in a spaced-apart relation from one another. The developer dispersion unit may also have at least two partitions disposed between a first side wall and an opposed second side wall of the developing chamber adjacent to upper parts of the two openings. The at least two partitions preferably extend horizontally as long as the width of the corresponding opening, respectively.

Alternatively, the developer inlet may have one opening formed in a horizontal direction on the upper part of the developing chamber. The developer dispersion unit may also have at least two partitions located between a first side wall and an opposed second side wall of the developing chamber adjacent to an upper part of the one opening. The at least two partitions preferably extend horizontally in a spaced-apart relation to one another.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic view of a conventional wet electrophotographic printer;

FIG. 2 is a side view of a developing chamber of the conventional wet electrophotographic printer in FIG. 1 with a cover of a manifold removed from the developing chamber;

FIG. 3 is a graph illustrating speed distribution of a developer at an outlet of the developing chamber of FIG. 2;

FIG. 4 is a schematic view of a wet electrophotographic printer having a developer supplying apparatus in accordance with an embodiment of the present invention;

FIG. 5 is a perspective view of a developing chamber of the wet electrophotographic printer having the developer supplying apparatus of FIG. 4;

FIG. 6 is an exploded perspective view of the developing chamber of the wet electrophotographic printer having the developer supplying apparatus of FIG. 5;

FIG. 7 is a side view of the developing chamber of the wet electrophotographic printer having the developer supplying apparatus of FIG. 5 with a cover of a manifold removed;

FIG. 8 is a graph illustrating speed distribution a liquid developer at an outlet of the developing chamber of the wet electrophotographic printer having the developer supplying apparatus of FIG. 5; and

FIG. 9 is a side view of a developing chamber of a wet electrophotographic printer having a developer supplying apparatus in accordancee with an alternative embodiment of the present invention with a cover of a manifold removed.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

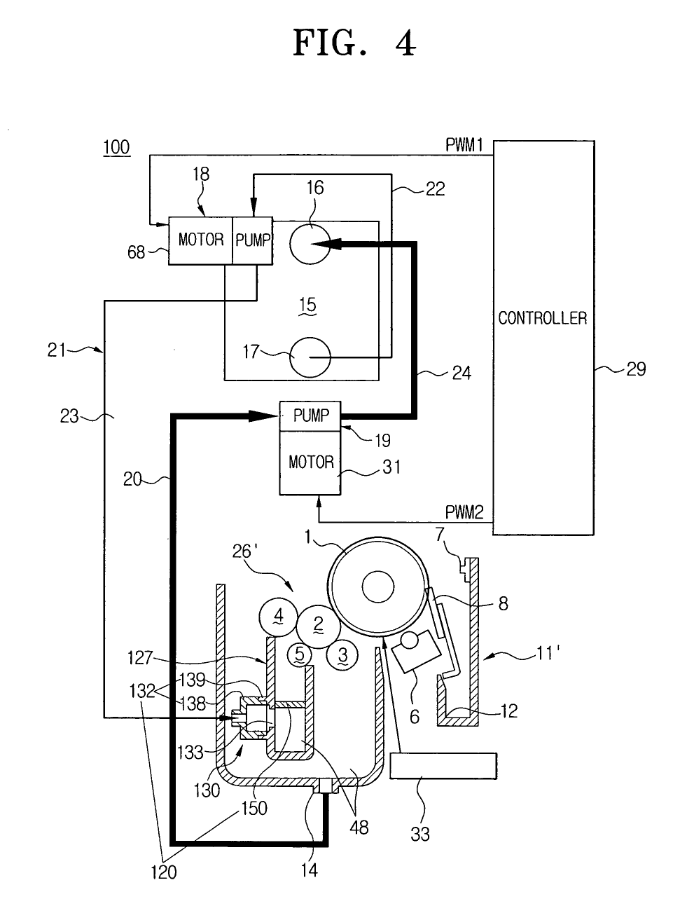

FIG. 4 is a schematic view of an image forming apparatus employing a developer supplying apparatus in accordance with an exemplary embodiment of the present invention.

The image forming apparatus is a wet electrophotographic printer 100 that performs a printing operation by processing print data transmitted from a computer (not shown).

Referring to FIG. 4, the wet electrophotographic printer 100 includes an image forming unit 11′ and a developer supplying unit 21.

The image forming unit 11′ includes a photoconductor 1 such as an OPC drum, a laser scanning unit 33, a charging unit 6, a discharging unit 7, a developing unit 26′, and a cleaning blade 8.

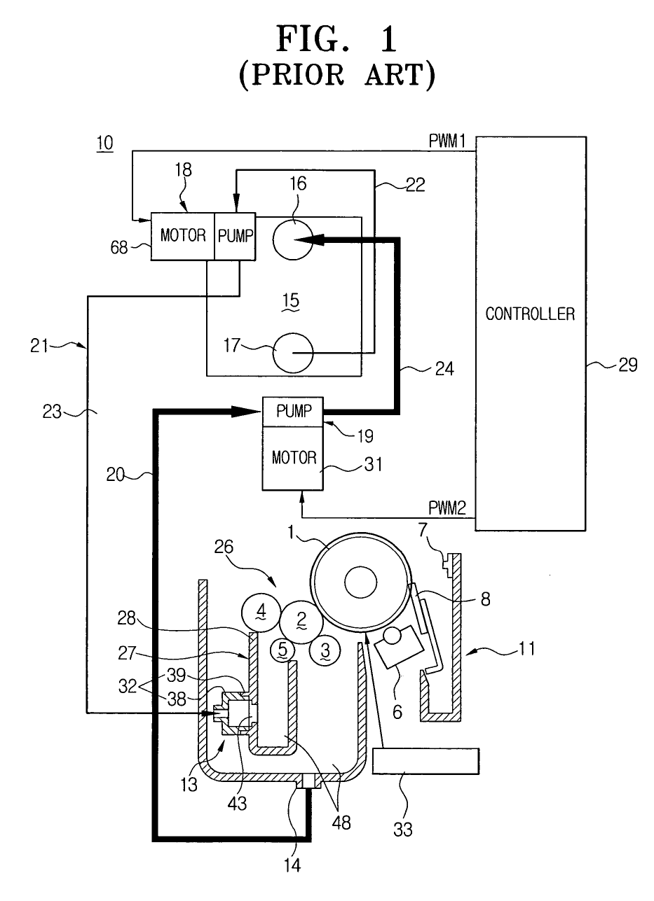

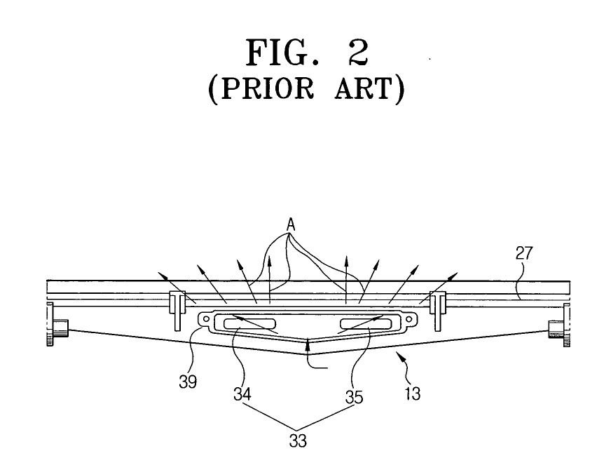

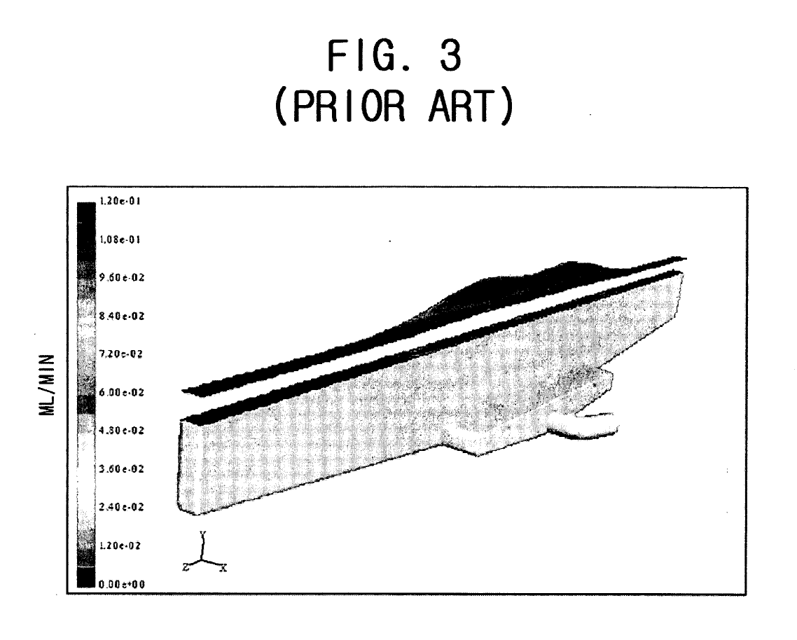

The construction of a photoconductor 1, the laser scanning unit 33, the charging unit 6, the discharging unit 7, and the cleaning blade 8 except for the developing unit 26′, is substantially the same as that of the conventional image forming unit 11 explained with reference to FIG. 1, and thus, the further detailed explanation thereof will be omitted for clarity and conciseness.

The developing unit 26′ includes a developing chamber 127, a developing roller 2, a deposit roller 5, a metering roller 3, a cleaning roller 4, and a recovery chamber 28.

The developing chamber 127 retains a liquid developer 48 therein. The developing chamber 127 is provided at a lower side thereof with a first developer inlet 13′. The developing chamber 127 supplies liquid developer 48 from a developer cartridge 15 to the developing chamber 127 via first and second connection tubes 22 and 23.

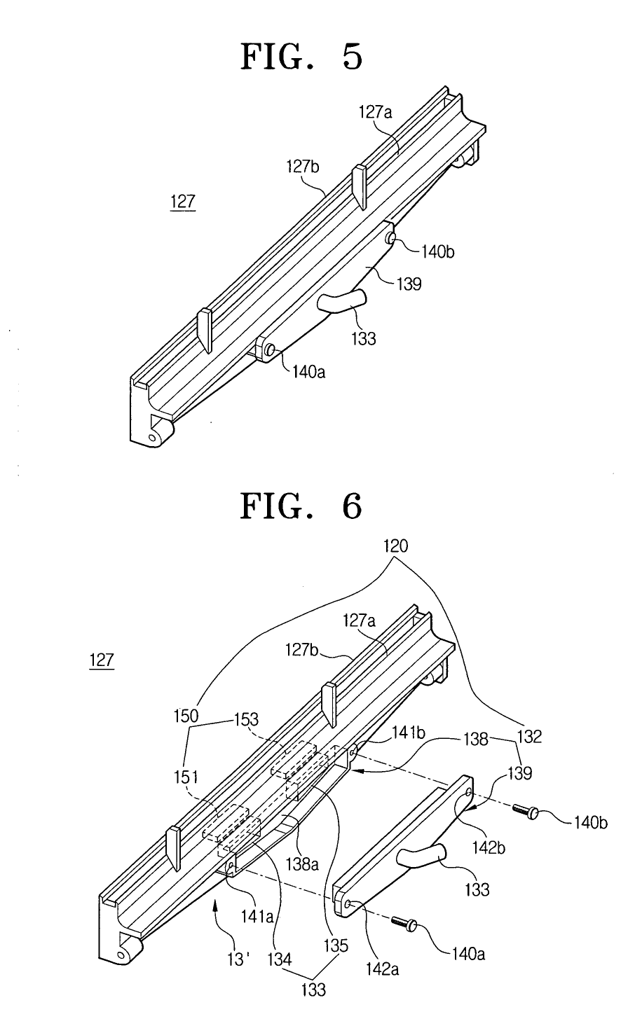

As illustrated in FIGS. 5 and 6, the first developer inlet 13′ includes a developer supplying apparatus 120 to maintain the flow dispersion of the liquid developer 48 supplied into the developing chamber 127 of the developing unit 26′ uniform.

The developer supplying apparatus 120 has a manifold 132 and a developer dispersion unit 150.

The manifold 132 is connected to the second connection tube 23 to supply the liquid developer 48 from the developer cartridge 15 to the developing chamber 127 of the developing unit 26′.

The manifold 132 has a flange 138 and a cover 139. The flange 138 protrudes from a lower part of a first side wall 127a of the developing chamber 127 to form a developer moving recess 138a in the center thereof. The developer moving recess 138a of the flange 138 is provided with a developer inlet 133 through which the liquid developer 48 flows into the developing chamber 127. The developer inlet 133 is formed with first and second elongated openings 134 and 135 spaced apart from each other.

The cover 139 seals the developer moving recess 138a of the flange 138. The cover includes developer inlet connector 133 connected to the second connection tube 23. The cover 139 is preferably inserted and fixed to the flange 138 by a suitable conventional fasteners 140a and 140b such as screws which can be inserted into threaded holes 141a and 141b and 142a and 142b.

The developer dispersion unit 150 has first and second dispersion partitions 151 and 153 disposed in the developing chamber 27. The first and second dispersion partitions 151 and 153 are located adjacent to an upper part of the first and second openings 134 and 135 of the developer inlet 133. As shown in FIGS. 4 and 6, the first and second partitions 151 and 153 horizontally extend as long as the width of the first and second openings 134 and 135 between a first side wall 127a and an opposed second side wall 127b of the developing chamber 127.

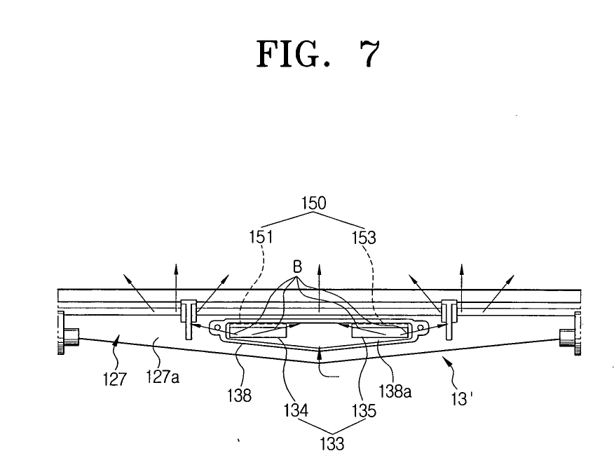

The developer dispersion unit 150 guides the liquid developer 48 in such a way that the liquid developer 48 flowing into the lower part of the developing chamber 127, through the first and second openings 134 and 135, does not move directly toward the upper part of the developing chamber 127. The liquid developer 48 is dispersed in a horizontal direction (indicated by an arrow B in FIG. 7). As a result, as shown in FIG. 7, the liquid developer 48 does not concentrate in the upper center portion between the first and second openings 134 and 135, but is uniformly dispersed over the longitudinal edges of the developing chamber 127.

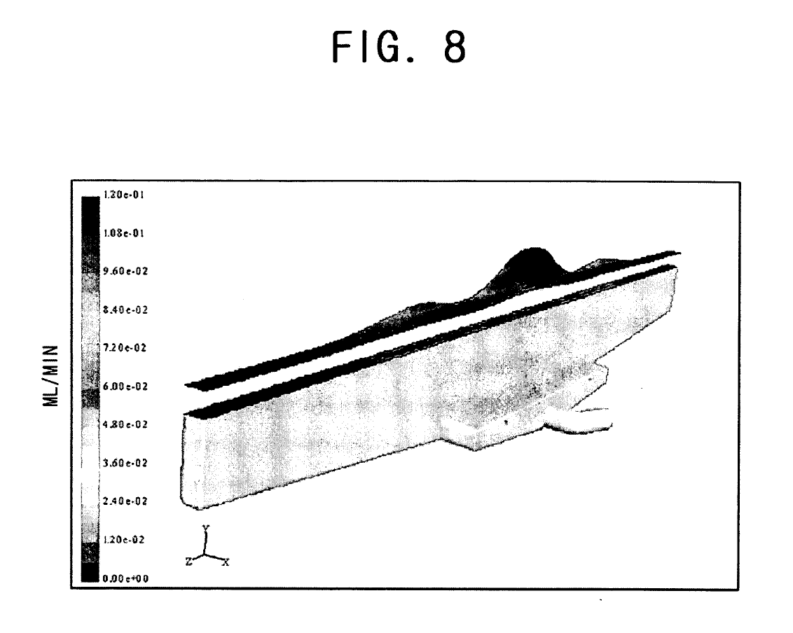

FIG. 8 is a graph illustrating the speed distribution of the liquid developer 48 at an outlet near the upper part of the developing chamber 127 having the developer supplying apparatus 120 as illustrated in FIGS. 4 to 7. As apparent from the graph in FIG. 8, the liquid developer 48 is not concentrated in the center between the first and second openings 134 and 135 of the developer inlet 133, but is evenly supplied to longitudinal edges of the developing chamber 127. According to the measurement, the liquid developer 48 was supplied at a speed of about 50% (that is, 450 ml/min) of the standard (900 ml/min). Moreover, an image defect, such as a snow flake, was not formed in the final image formed.

The developing roller 2 is positioned at a lower part of the photoconductor 1, and is cleaned by the cleaning roller 4. The deposit roller 5 applies an electric force to the liquid developer 48 to form a charged developer layer on the developing roller 2. The metering roller 3 restricts the charged developer layer formed on the developing roller 2 by the deposit roller 5 to a developer layer having a constant toner amount or concentration (% Solid). Moreover, the metering roller 3 supplies the developer layer into a nip between the developing roller 2 and the photoconductor 1.

The recovery chamber 28 recovers the liquid developer 48 that has overflowed from the developing chamber 127. The recovery chamber 28 is provided at the lower part thereof with a first developer discharging part 14 for discharging the liquid developer 48 overflowed from the developing chamber 127 into the developer cartridge 15 through third and fourth connection tubes 20 and 24.

The developer supplying unit 21 is provided with a developer cartridge 15, a developer supplying pump 18, a developer recovery pump 19, and a controller 29.

The developer cartridge 15 constitutes a developer storing chamber, and has a second developer inlet 16 and a second developer outlet 17.

The developer supplying pump 18 is interposed between the first and second connection tubes 22 and 23 to pump the liquid developer 48 from the second developer outlet 17 of the developer cartridge 15 to the first developer inlet 13′ of the developing chamber 127.

The developer recovery pump 19 is interposed between the third and fourth connection tubes 20 and 24 to pump the liquid developer 48 from the second developer outlet 14 of the recovery chamber 28 to the second developer inlet 16 of the developing cartridge 15. If the developer supplying unit 21 is disposed on the lower part of the developing unit 26′, the developer recovery pump 19 may not be installed, and in this case, the liquid developer falls free into the developer cartridge 15.

The controller 29 controls first and second DC motors 68 and 31 for driving the developer supplying pump 18 and the developer recovery pump 19.

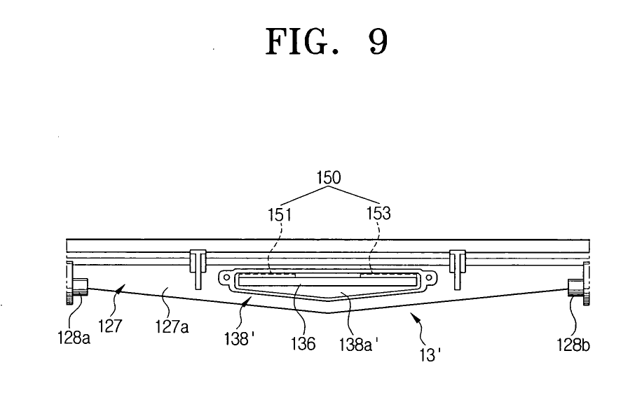

In the developer supplying apparatus 120 for the wet electrophotographic printer in accordance with an embodiment of the present invention, although the developer inlet 133 of the manifold 132 is described and shown to have the first and second openings 134 and 135 and the developer dispersion unit 150 is described and shown to have the first and second partitions 151 and 153 adjacent to the first and second openings 134 and 135 over the first and second openings, other suitable arrangements and constructions may be used. As shown in FIG. 9, a developer inlet 136 may have one opening formed on a developer moving recess 138a′ of a flange 138′, and a developer dispersion unit 150 may have at least two partitions 151 and 153 spaced apart from each other at a constant interval on an upper part of one opening in order to connect the first side wall 127a of the developing chamber 127 with the second side wall 127b opposite to the first side wall.

In the developer supplying apparatus 120 for the wet electrophotographic printer in accordance with an embodiment of the present invention, although the flange 138 and the cover 139 of the manifold 132 and the developer inlet 133 are described and shown to be disposed on the lower part of the first side wall 127a, they may be disposed in another position to supply the liquid developer 48 into the developing chamber 127. For example, they may be disposed on a bottom or other side wall 127b of the developing chamber 127.

The operation of the wet electrophotographic printer having the developer supplying apparatus 120 as described above will now be described in detail with reference to FIGS. 4 through 8.

First, as a print command is applied to the printer, a drive voltage applied from a power supply (not shown) to the first DC motor 68 is controlled by a first PWM signal (PWM1) from the controller 29. Thus the developer supplying pump 18 is driven accordingly to supply the liquid developer 48 from the developer cartridge 15 to the manifold 132 of the developer supplying apparatus 120 through the second connection tube 23.

The liquid developer 48 supplied to the manifold 132 flows into the lower part of the developing chamber 127 through the first and second openings 134 and 135 of the developer inlet 133. At that time, as shown in FIG. 7, the liquid developer 48 does not move directly toward the upper part of the developing chamber 127, but is dispersed in a horizontal direction (as indicated by an arrow B in FIG. 7). As a result, the liquid developer 48 is not concentrated upon the upper center between the first and second openings 134 and 135, but is uniformly dispersed into the longitudinal edges of the developing chamber 127, and then moves to the upper part of the developing chamber 127.

At this time, after a surface electric potential is removed from the photoconductor 1 by the discharging unit 7, a charged layer such as an electrostatic latent image, corresponding to an image to be printed is formed on the photoconductor 1 by the charging unit 6 and the laser scanning unit 33.

The liquid developer 48, which is dispersed up from the lower part of the developing chamber 127 by the first and second partitions 151 and 153 of the developer supplying apparatus 150, is formed as a developer layer having a high toner amount by the deposit roller 5, the metering roller 3 and the developing roller 2 of the developing unit 26′. The liquid developer 48 is then attached to a part of the photoconductor 1 on which the electrostatic latent image is formed, so that the toner image is formed.

The toner image developed on the photoconductor 1 by the developing unit 26′ is transferred to a recording paper through a transfer belt (not shown) and a transfer roller (not shown), and is then fixed onto the recording paper through the fixing roller (not shown) to form the final image.

The liquid developer 48 that has not been transferred to the transfer belt, but has remained on the photoconductor 1, is removed and stored by the cleaning blade 8 into a wasted developer container 12. Then, the photoconductor 1 repeats the above-described process to print the next image through the discharging unit 7, the charging unit 6, the laser scanning unit 33 and the developing unit 26′.

Meanwhile, a drive voltage applied from the power supply to the second DC motor 31 is controlled by a second PWM signal (PWM2) from the controller 29. Thus the developer recovery pump 19 is driven accordingly to recover the liquid developer 48 overflowed from the developing chamber 127 into the developer cartridge 15.

When the printing process is completed, the polarity of the drive voltage applied from the power source to the first DC motor 68 is changed to an opposite polarity by the first PWM signal (PWM1) from the controller 29. Thus the developer supplying pump 18 is reversely rotated to recover the liquid developer 48 remaining in the developing chamber 127 to the developer cartridge 15, thereby completing the printing process.

As described above, according to the present invention, the developer supplying apparatus 120 includes the developer dispersion unit 150 for guiding the liquid developer 48 in such a way that the liquid developer 48 flowing into the lower part of the developing chamber 127 and does not directly move toward the upper part of the developing chamber 127. Therefore, the liquid developer 48 is dispersed in a horizontal direction. Accordingly, the liquid developer 48 is uniformly dispersed over the whole part of the developing chamber 127, and image defects such as snow flakes are not formed in the final image, thus maintaining image quality.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for uniformly supplying a developer of an image forming apparatus, comprising:
a manifold connected to a connection tube for supplying a liquid developer from an outside and having a developer inlet through which the liquid developer flows into a developing chamber; and
a developer dispersion unit, disposed in the developing chamber and located adjacent to an upper part of the developer inlet to guide the liquid developer flowing into the developing chamber through the developer inlet so that the liquid developer is dispersed in a substantially horizontal direction.

2. The apparatus of claim 1, wherein the developer inlet has at least two openings formed on a lower part of the developing chamber in a spaced apart relation from one another; and
wherein the developer dispersion unit has at least two partitions disposed between a first side wall and an opposed second side wall of the developing chamber adjacent to upper parts of the two openings, the at least two partitions extend horizontally as long as the width of the corresponding opening, respectively.

3. The apparatus of claim 1, wherein the developer inlet has one opening formed in a horizontal direction on the lower part of the developing chamber; and
wherein the developer dispersion unit has at least two partitions disposed between a first side wall and an opposed second side wall of the developing chamber adjacent to an upper part of the one opening, the at least two partitions extend horizontally in a spaced-apart relation from one another.

4. An image forming apparatus comprising:
an image forming unit having a developing unit, provided with a developing chamber for retaining a liquid developer therein to form an image by developing an electrostatic latent image using the liquid developer;
a developer supplying unit having a developer cartridge to store the liquid developer therein, a connection tube for connecting the developing unit with the developer cartridge, and at least one developer pump for supplying the liquid developer from the developer cartridge to the developing unit through the connection tube and recovering the liquid developer from the developing unit to the developer cartridge through the connection tube; and
a uniform developer supplying apparatus to maintain a uniform flow dispersion of the liquid developer supplied into the developing chamber of the developing unit;
wherein the developer supplying apparatus comprises a manifold connected to the connection tube and a developer inlet through which the liquid developer flows into the developing chamber, and a developer dispersion unit which is disposed in the developing chamber and located adjacent to an upper part of the developer inlet to guide the liquid developer flowing into the developing chamber through the developer inlet so that the liquid developer is dispersed in a horizontal direction.

5. The apparatus of claim 4, wherein the developer inlet has at least two openings formed on a lower part of the developing chamber in a spaced-apart relation from one another; and
wherein the developer dispersion unit has at least two partitions disposed between a first side wall and an opposed second side wall of the developing chamber adjacent to upper parts of the two openings, the at least two partitions extend horizontally as long as the width of the corresponding opening, respectively.

6. The apparatus of claim 5, wherein the developer inlet has one opening formed in a horizontal direction on the upper part of the developing chamber; and
wherein the developer dispersion unit has at least two partitions disposed between a first side wall and an opposed second side wall of the developing chamber adjacent to an upper part of the one opening, the at least two partitions extend horizontally in a spaced-apart relation from each other.

7. A method for uniformly supplying a developer of an image forming apparatus, comprising the steps of:
supplying a liquid developer from an outside and having a developer inlet through which the liquid developer flows into a developing chamber; and
guiding the liquid developer flowing into the developing chamber through the developer inlet so that the liquid developer is dispersed in a substantially horizontal direction.

8. The method of claim 7, wherein the developer inlet has at least two openings formed on a lower part of the developing chamber in a spaced apart relation from one another.

9. The method of claim 7, wherein the developer inlet has one opening formed in a horizontal direction on the lower part of the developing chamber.
